(19) United States
(12) Patent Application Publication
(10) Pub. No.: US 2016/0232861 A1
(43) Pub. Date: Aug. 11, 2016

(54) BLACK PIXEL INSERTING METHOD OF 3D DISPLAY AND CIRCUIT USING THE METHOD

(71) Applicant: SHENZHEN CHINA STAR OPTOELECTRONICS TECHNOLOGY CO. LTD., Shenzhen, Guangdong (CN)

(72) Inventor: Peng DU, Shenzhen, Guangdong (CN)

(73) Assignee: Shenzhen China Star Optoelectronics Technology Co. Ltd., Shenzhen, Guangdong (CN)

(21) Appl. No.: 14/378,605

(22) PCT Filed: Jul. 2, 2014
(86) PCT No.: PCT/CN2014/081438

§ 371 Date: Aug. 13, 2014

(30) Foreign Application Priority Data
Jun. 12, 2014 (CN) 201410262334.6

(51) Int. Cl. G09G 3/36; G09G 3/00

(52) U.S. Cl. CPC G09G 3/3614; G09G 3/003; G09G 3/3677; G09G 3/3688; G09G 2310/0251; G09G 2310/061; G09G 2320/0209; G09G 2320/0252; G09G 2330/021

(57) ABSTRACT

The present invention relates to a black pixel inserting method for 3D display. Multiple data lines for supplying data signals, multiple gate lines for supplying scan signals, and multiple pixels are provided. Each pixel is electrically connected to one data line and one gate line, and the polarity of each pixel is opposite to that of neighboring pixels on the top, bottom, left and right of the pixel. Multiple control transistors for connecting the pixels with different polarities are provided. Multiple control signal terminals electrically connected with the control transistors are provided. When the control signal terminals are applied with a logic low voltage, the control transistors are switched-off, and when the control signal terminals are applied with a logic high voltage, the control transistors are switched-on. In addition, the present invention also provides a circuit using the above method.

### TECHNICAL FIELD

The present invention relates to the field of display, and particularly to a black pixel inserting method for 3D display and a circuit using such method.

### DESCRIPTION OF RELATED ART

Recently, the demands of 3D display function are rapidly growing. The shutter-type 3D technology increases the frame refreshing rate and divides one frame of image into alternately-displayed two groups of image frames respectively corresponding to left and right eyes, and thereby viewers can watch 3D display effect by wearing shutter-type glasses. In the shutter-type 3D technology, it is easy to occur crosstalk problem during the left-eye and right-eye image frames are alternately displaying. The crosstalk problem is that: the received left-eye image contains right-eye image information, and the received right-eye image contains left-eye image information, i.e., the left-eye image and right-eye image are interfered with each other, rendering the synthesized 3D image unsatisfactory.

The occurrence of crosstalk primarily includes the following two reasons. The first reason is that the screen display of liquid crystal display device uses a manner of progressive scanning from top to down. When the liquid crystal display device displays a left-eye image, the left eye receives the left-eye image, immediately following the left-eye image is scanned to the last row, the right-eye image is started to scan the first row, and the right eye starts to receive the right-eye image. However, since the second to the last rows of the liquid crystal display screen at this time are maintained with the previous one frame of left-eye image, so that the right-eye image received by the right eye would contain some information of left-eye image. Likewise, the left-eye image received by the left eye also would contain some information of right-eye image. As a result, the left-eye and right-eye images crosstalk occur. The second reason is that the deflection of liquid crystal molecules needs a certain of time, and such time is the liquid crystal response time. The screen display of the liquid crystal display device uses the manner of progressive scanning from top to down, when displaying a left-eye image, the left eye receives the left-eye image, immediately following the left-eye image is scanned to the last row to finish the scanning, it is started to scan the right-eye image from the first row, the right eye starts to receive the right-eye image. In this situation, the first row of liquid crystal cells changes from the left-eye image to the right-eye image, driving voltages on the first row of liquid crystal cells needs to be changed so as to vary the deflection angles of the first row of liquid crystal cells. However, since the deflection of liquid crystal cell needs a certain of liquid crystal response time, the received right-eye image would contain the process of changing from the left-eye image to the right-eye image. That is, during the liquid crystal response time, the right eye simultaneously receives the left-eye image and the right-eye image, and thereby occurs the crosstalk of left-eye and right-eye images.

As to the first reason of crosstalk occurrence, it can be solved by inserting a black image between left-eye image and right-eye image, for example, using the display manner of left-eye image frame->black image frame->right-eye image frame->black image frame (i.e., LBRB) to make the left eye simultaneously receive the left-eye image and black image, and the right eye simultaneously receive the right-eye image and black image. Since the black images are background images, and therefore would not interfere with the normal images (i.e., left-eye and right-eye images). The black insertion (BI) technology is commonly used in flat display devices so as to improve the dynamic image display quality of display panel. In particular, by inserting a black image between successive dynamic images, the integration effect of image with respect to human eyes can be eliminated, the phenomenon of moving picture response timing in the dynamic images of the display panel can be further improved and thereby the quality of moving picture is improved. As to the second reason of crosstalk occurrence, it can be solved by shortening the liquid crystal response time.

At present, a conventional black insertion is using data lines to write black image signal into pixels, so as to achieve the purpose of black insertion. Referring to FIG. 1a, which is a schematic view of a conventional black inserting circuit. The circuit includes a data line Data11 for supplying a data signal, a gate line Gatell crossing over the data line Data11 and for supplying a scan signal, a common electrode VCOM11, a pixel transistor Tr11, a pixel electrode D11, a storage capacitor C_{stg}11 and a liquid crystal capacitor C_{LC}11. The pixel transistor Tr11 includes a gate g11, a source s11 and a drain d11. The gate g1 of the pixel transistor Tr11 is electrically connected to the gate line Gate11, the source s11 of the pixel transistor Tr11 is electrically connected to the data line Data11, and the drain d11 of the pixel transistor Tr11 is electrically connected to the pixel electrode D11. A top plate of the storage capacitor C_{stg}11 and a top plate of the liquid crystal capacitor C_{LC}11 are together electrically connected to the pixel electrode D11, a bottom plate of the storage capacitor C_{stg}11 is electrically connected to the common electrode VCOM11, and a bottom plate of the liquid crystal capacitor C_{LC}11 is electrically connected to the common electrode VCOM11. The pixel transistor Tr11 is a thin film transistor (TFT). A path indicated by the arrows in FIG. 1a is a writing path of black image signal. However, the voltage switching frequency on the data line Data11 is high, which would result in the increase of power consumption. According to relevant data, the use of such conventional black inserting method would increase 20%-40% power consumption in total.

Another conventional black insertion is connecting a pixel electrode of a pixel with a common electrode by a certain circuit structure (e.g., TFT). The pixel electrode is discharged to the common electrode when a black image is needed to be inserted, so as to achieve the purpose of black insertion. Referring to FIG. 1b, which is a schematic view of another conventional black inserting circuit. The circuit includes a data line Data11′ for supplying a data signal, a gate line Gate11′ crossing over the data line Data11′ and for supplying a scan signal, a control signal terminal 11′, a common electrode VCOM11′, a pixel transistor Tr11′, a control transistor T12′, a pixel electrode D11′, a storage capacitor C_{stg}11′ and a liquid crystal capacitor C_{LC}11′. The pixel transistor Tr11′ includes a gate g11′, a source s11′ and a drain d11′. The control transistor T12′ includes a gate g12′, a source s12′ and a drain d12′. The gate g11′ of the pixel transistor Tr11′ is electrically connected to the gate line Gate11′, the source s11′ of the pixel transistor Tr11′ is electrically connected to the data line Data11′, and the drain d11′ of the pixel transistor Tr11′ is electrically connected to the pixel electrode D11′. A top plate of the storage capacitor C_{stg}11′ and a top plate of the liquid crystal capacitor C_{LC}11′ are together electrically connected to the pixel electrode D11′, a bottom plate of the storage capacitor C_{stg}11′ is electrically coupled to the common electrode VCOM11′, and a bottom plate of the liquid crystal capacitor C_{LC}11′ is electrically connected to the common electrode VCOM11′. The source s12′ of the control transistor T12′ is electrically connected to the pixel electrode D11′, the gate g12′ of the control transistor T12′ is electrically connected to the control signal terminal 11′, and the drain d12′ of the control transistor T12′ is electrically coupled to the common electrode VCOM11′. The pixel transistor Tr11′ and the control transistor T12′ both are thin film transistors. The path indicated by the arrows in FIG. 1b is a discharging path of pixel electrode. However, the load on the common electrode VCOM11′ is large, which would influence the display quality.

### SUMMARY

An objective of the present invention is to provide a black pixel inserting method for 3D display, so as to achieve the function of black insertion for 3D display without increasing the power consumption of panel, and would not additionally increase the load of common electrode circuitry.

Another objective of the present invention is to provide a circuit using the black pixel inserting method for 3D display, so as to achieve the display of black image by switching on a thin film transistor connecting pixel electrodes with different polarities by a control signal.

In order to achieve the above objective, in one aspect, a black pixel inserting method for 3D display includes:

step 100: providing multiple data lines for supplying data signals, multiple gate lines for supplying scan signals, and multiple pixels, each pixel being connected to one data line and one gate line, and a polarity of each pixel being opposite to that of neighboring pixels on the top, bottom, left and right of the pixel;

step 200: providing multiple control transistors for connecting the pixels with different polarities; and

step 300: providing multiple control signal terminals connected with the control transistors, when the control signal terminals being applied with a logic low voltage, the control transistors being switched-off, and whereas when the control signal terminals being applied with a logic high voltage, the control transistors being switched-on.

In an exemplary embodiment, in the step 200, each control transistor is electrically connected a (2n+1)th row of pixel with a (2n+2)th row of pixel arranged in a same column.

In an exemplary embodiment, in the step 200, each control transistor is electrically connected a (2n+1)th column of pixel with a (2n+2)th column of pixel arranged in a same row.

In an exemplary embodiment, in the step 100, each pixel includes an upper half domain and a lower half domain, and the upper half domain and the lower half domain have a same polarity.

In an exemplary embodiment, in the step 200, each control transistor is electrically connected the lower half domain of a mth row of pixel with the upper half domain of a (m+1)th row of pixel arranged in a same column.

In an exemplary embodiment, when the control transistors are switched-on, voltages of the pixels with positive polarity decrease, voltages of the pixels with negative polarity increase, and finally reach close to a voltage of common electrode.

In another aspect, a circuit using the above black pixel inserting method for 3D display according to an exemplary embodiment of the present invention includes: multiple data lines for supplying data signals, multiple gate lines for supplying scan signals, multiple of control signal terminals, a common electrode, multiple pixels defined by the data lines and the gate lines, and multiple control transistors. Each of the pixels is electrically connected to one of the data lines and one of the gate lines. Each of the pixels includes a pixel transistor, a pixel electrode, a storage capacitor and a liquid crystal capacitor. Each of the control transistors includes a gate, a source and a drain. The pixel transistor includes a first gate, a first source and a first drain.

A (2n+1)th row of pixel and a (2n+2)th (n=0, 1, 2 . . . ) row of pixel arranged in a same column are electrically connected by one of the control transistors. The source of the control transistor is electrically connected to the pixel electrode of the (2n+1)th row of pixel, and the drain of the control transistor is electrically connected to the pixel electrode of the (2n+2)th row of pixel. The gates of the control transistors arranged in a same row are electrically connected to a same one of the control signal terminals.

The first gates of the pixel transistors of the pixels arranged in a same row are electrically connected to a same one of the gate lines, the first sources of the pixel transistors of the pixels arranged in a same column are electrically connected to a same one of the data lines. The first drain of the pixel transistor is electrically connected to the pixel electrode. A top plate of the storage capacitor and a top plate of the liquid crystal capacitor are together electrically connected to the pixel electrode, a bottom plate of the storage capacitor is electrically connected to the common electrode, and a bottom plate of the liquid crystal capacitor is electrically connected to the common electrode.

In an exemplary embodiment, the control transistors and the pixel transistor are thin film transistors.

In an exemplary embodiment, a polarity of each of the pixels is opposite to that of neighboring pixels on the top, bottom, left and right of the pixel.

In still another aspect, a circuit using the above black pixel inserting method for 3D display according to an exemplary embodiment of the present invention includes: multiple data lines for supplying data signals, multiple gate lines for supplying scan signals, control signal terminals, a common electrode, multiple pixels defined by the data lines and the gate lines, and multiple control transistors. Each of the pixels is electrically connected to one of the data lines and one of the gate lines. Each of the pixels includes a pixel transistor, a pixel electrode, a storage capacitor and a liquid crystal capacitor. Each of the control transistors includes a gate, a source and a drain. The pixel transistor includes a first gate, a first source and a first drain.

A (2n+1)th column of pixel and a (2n+2)th (n=0, 1, 2 . . . ) column of pixel arranged in a same row are electrically connected by one of the control transistors. The source of the control transistor is electrically connected to the pixel electrode of the (2n+1)th colum of pixel, and the drain of the control transistor is electrically connected to the pixel electrode of the (2n+2)th column of pixel. The gates of the control transistors arranged in a same row are electrically connected to a same one of the control signal terminals.

The first gates of the pixel transistors of the pixels arranged in a same row are electrically connected to a same one of the gate lines, the first sources of the pixel transistors of the pixels arranged in a same column are electrically connected to a same one of the data lines, and the first drain of the pixel transistor is electrically connected to the pixel electrode. A top plate of the storage capacitor and a top plate of the liquid crystal capacitor are together electrically connected to the pixel electrode, a bottom plate of the storage capacitor is electrically connected to the common electrode, and a bottom plate of the liquid crystal capacitor is electrically connected to the common electrode.

In an exemplary embodiment, the control transistors and the pixel transistor are thin film transistors.

In an exemplary embodiment, a polarity of each of the pixels is opposite to that of neighboring pixels on the top, bottom, left and right of the pixel.

In even still another aspect, a circuit using the above black pixel inserting method for 3D display according to an exemplary embodiment of the present invention includes: multiple data lines for supplying data signals, multiple gate lines for supplying scan signals, multiple control signal terminals, a common electrode, multiple pixels defined by the data lines and the gate lines, and multiple control transistors. Each of the pixels is electrically connected to one of the data lines and one of the gate lines. Each of the control transistors includes a gate, a source and a drain. Each of the pixels comprises an upper half domain and a lower half domain, a first pixel electrode in the upper half domain and a second pixel electrode in the lower half domain have a same polarity. The upper half domain includes a first pixel transistor and the first pixel electrode, and the lower half domain includes a second pixel transistor and the second pixel electrode. The first pixel transistor includes a gate, a source and a drain, the second pixel transistor includes a gate, a source and a drain. The drain of the first pixel transistor is electrically connected to the first pixel electrode, and the drain of the second pixel transistor is electrically connected to the second pixel electrode. The gates of the first pixel transistors and the gates of the second pixel transistors of the pixels arranged in a same row are electrically connected to a same one of the gate lines. The source of the first pixel transistor and the source of the second pixel transistor of the pixel arranged in a mth (m=1, 2 . . . ) row are electrically connected to a same one of the data lines, the source of the first pixel transistor and the source of the second pixel transistor of the pixel arranged in a (m+1)th row are electrically connected to another same one of the data lines.

The lower half domain of the mth row of pixel and the upper half domain of the (m+1)th row of pixel arranged in a same column are electrically connected by one of the control transistors. The source of the control transistor is electrically connected to the second pixel electrode in the lower half domain of the mth row of pixel, the drain of the control transistor is electrically connected to the first pixel electrode in the upper half domain of the (m+1)th row of pixel. The gates of the control transistors arranged in a same row are electrically connected to a same one of the control signal terminals.

In an exemplary embodiment, the control transistors, the first pixel transistor and the second pixel transistor all are thin film transistor.

In an exemplary embodiment, a polarity of each of the pixels is opposite to that of neighboring pixels on the top, bottom, left and right of the pixel.

Beneficial effects can be achieved by the present invention are that: the present invention provides a black pixel inserting method for 3D display and a circuit using the method, aiming at the commonly used inversion manners (such as column inversion, row inversion and dot inversion, etc.) re-designing a 3D black insertion manner of panel. In the commonly used inversion manners, pixels with positive polarity and pixels with negative polarity respectively generally are a half of all pixels in the panel during normal display, according to the present invention, pixel electrodes with different polarities are electrically connected by a thin film transistor. When there is a need of black insertion, the thin film transistor connecting the pixel electrodes with different polarities is switched on by a control signal, the voltage of pixel with positive polarity decreases, the voltage of pixel with negative polarity increases, and finally both voltages reach close to a voltage of common electrode, and thereby achieving the display of black image. Accordingly, the present invention would not increase the load of the common electrode circuitry and power consumption of whole panel. Furthermore, the voltage between the source and the drain (corresponding to positive and negative pixel electrodes) of the thin film transistor for discharging is large, and thus the discharging speed is increased consequently.

The present invention will now be described more specifically with reference to the following embodiments. It is to be noted that the following descriptions of embodiments are presented herein for purpose of illustration and description only. It is not intended to be exhaustive or to be limited to the precise form disclosed.

### BRIEF DESCRIPTION OF THE DRAWINGS

The above embodiments will become more readily apparent to those ordinarily skilled in the art after reviewing the following detailed description and accompanying drawings.

FIG. 1a is a schematic structural view of a conventional black inserting circuit.

FIG. 1b is a schematic structural view of another conventional black inserting circuit.

FIG. 2 is a flowchart of a black pixel inserting method for 3D display according to an exemplary embodiment of the present invention.

FIG. 3 is a schematic circuit diagram of a circuit using the black pixel inserting method for 3D display according to a first exemplary embodiment of the present invention.

FIG. 4 is a schematic circuit diagram of a circuit using the black pixel inserting method for 3D display according to a second exemplary embodiment of the present invention.

FIG. 5 is a schematic circuit diagram of a circuit using the black pixel inserting method for 3D display according to a third exemplary embodiment of the present invention.

### DETAILED DESCRIPTION OF EMBODIMENTS

The present invention will now be described more specifically with reference to the following embodiments. It is to be noted that the following descriptions of embodiments are presented herein for purpose of illustration and description only. It is not intended to be exhaustive or to be limited to the precise form disclosed.

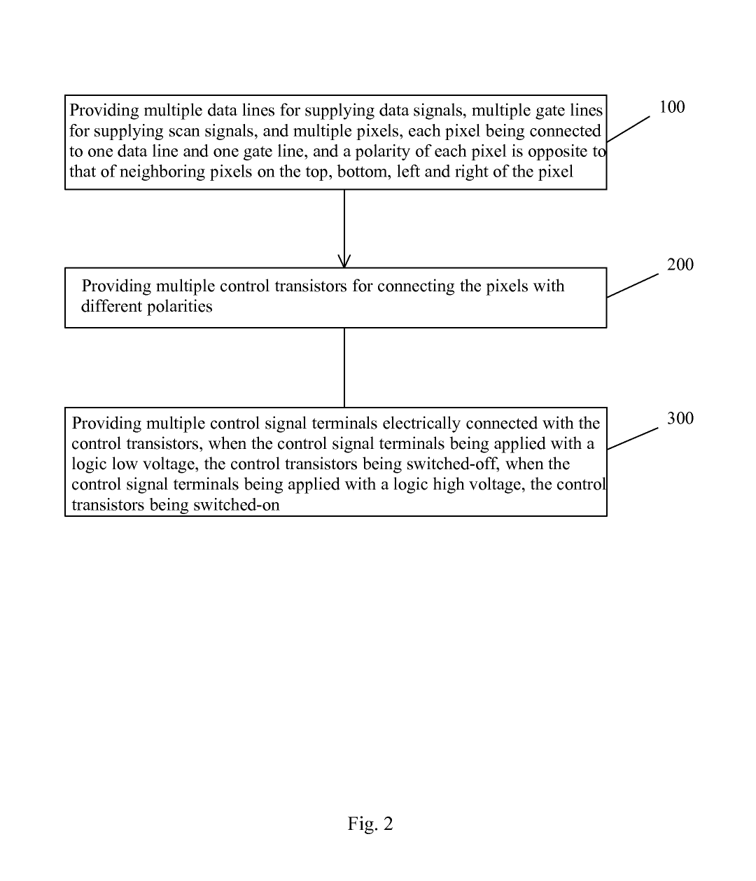

Referring to FIG. 2, a black pixel inserting method for 3D display according to an exemplary embodiment of the present invention includes the following several steps.

Step 100: multiple data lines for supplying data signals, multiple gate lines for supplying scan signals, and multiple pixels are provided. Each of the pixels is connected to one of the data lines and one of the gate lines, a polarity of each of the pixels is opposite to a polarity of neighboring pixels on the top, bottom, left and right of the pixel.

Step 200: multiple control transistors are provided for connecting the pixels with different polarities.

Step 300: multiple control signal terminals are provided to connect with the control transistors. When the control signal terminals are applied with a logic low voltage, the control transistors are switched-off. When the control signal terminals are applied with a logic high voltage, the control transistors are switched-on.

In one aspect, in the step 200, each of the control transistors electrically connects a (2n+1)th (n=0, 1, 2, . . . ) row of pixel with a (2n+2)th row of pixel arranged in a same column.

In another aspect, in the step 200, each of the control transistors electrically connects a (2n+1)th (n=0, 1, 2, . . . ) column of pixel with a (2n+2)th column of pixel arranged in a same row.

In still another aspect, in the step 100, each of the pixels can be divided into two domains, i.e., an upper half domain and a lower half domain. The upper half domain and the lower half domain have a same polarity.

Correspondingly, in the step 200, each of the control transistors electrically connects the bottom half domain of a mth (m=1, 2 . . . ) row of pixel with the upper half domain of a (m+1)th row of pixel arranged in a same column.

When the control transistor is switched-on, a voltage of the pixel with positive polarity connected with the switched-on control transistor decreases, a voltage of the pixel with negative polarity connected with the switched-on control transistor increases, and finally both voltages reach close to a voltage of common electrode.

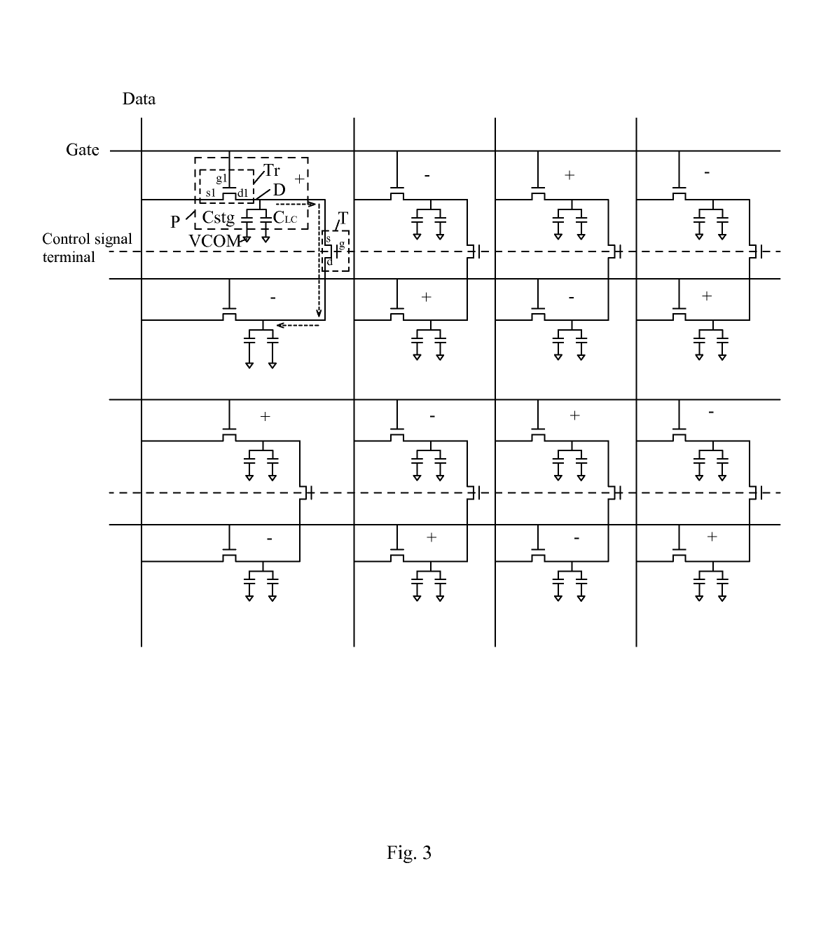

Referring to FIG. 3, which is a schematic circuit diagram of a circuit using the above black pixel inserting method for 3D display according to a first exemplary embodiment. In the first exemplary embodiment, the panel is a type of dot inversion panel. The symbols “+” and “−” in FIG. 3 respectively represent positive polarity and negative polarity of pixel electrode voltages. The circuit in the first exemplary embodiment includes multiple data lines Data for supplying data signals, multiple gate lines Gate for supplying scan signals, multiple control signal terminals, a common electrode VCOM, multiple pixels P defined by the data lines Data and the gate lines Gate, and multiple control transistors T. Each of the pixels P is electrically connected to one of the data lines Data and one of the gate lines Gate. Each of the pixels P includes a pixel transistor Tr, a pixel electrode D, a storage capacitor C_{stg} and a liquid crystal capacitor C_{LC}. Each of the control transistors T includes a gate g, a source s and a drain d. The pixel transistor Tr includes a first gate g1, a first source s1 and a first drain d1.

A (2n+1)th row of pixel and a (2n+2)th (n=0, 1, 2 . . . ) row of pixel in a same column are electrically connected by one of the control transistors T. The source s of the control transistor T is electrically connected to the pixel electrode D of the (2n+1)th row of pixel, the drain d of the control transistor T is electrically connected to the pixel electrode D of the (2n+2)th row of pixel. The gates g of the control transistors T arranged in a same row are electrically connected to a same one of the control signal terminals.

The first gates g1 of the pixel transistors Tr of th pixels P arranged in a same row are electrically connected to a same one of the gate lines Gate, and the first sources s1 of the pixel transistors Tr of the pixels P arranged in a same column are electrically connected to a same one of the data lines Data. The first drain d1 of each pixel transistor Tr is electrically connected to the pixel electrode D. A top plate of the storage capacitor C_{stg} and a top plate of the liquid crystal capacitor C_{LC} are together electrically connected to the pixel electrode D, a bottom plate of the storage capacitor C_{stg} is electrically connected to the common electrode VCOM, and a bottom plate of the liquid crystal C_{LC} is electrically connected to the common electrode VCOM.

The control transistors T and the pixel transistor Tr for example all are thin film transistors.

A polarity of each of the pixels P is opposite to a polarity of neighboring pixels P on the top, bottom, left and right of the pixel P.

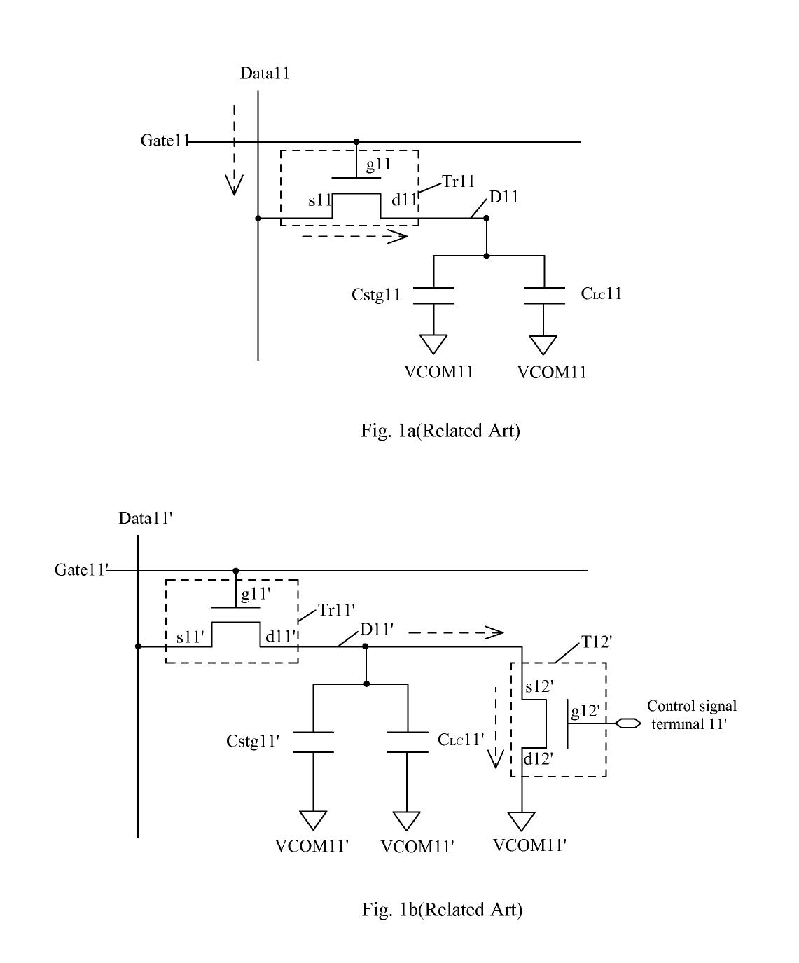

Specifically, a path indicated by the arrows in FIG. 3 is a current flowing path during black insertion, and the current flows from the pixel electrode with positive polarity to the pixel electrode with negative polarity. An operation process of the circuit using the above black pixel inserting method for 3D display according to the first exemplary embodiment may be that: during left-eye and right-eye images are written, the control signal terminals are applied with a logic low voltage, and the control transistors T are switched-off; when a black image is needed to be written, the control signal terminals are applied with a logic high voltage, the control transistors T are switched on, since the polarities of the (2n+1)th row of pixel and the (2n+2)th row of pixel in a same column are opposite, a voltage of the pixel with positive polarity gradually decreases, while a voltage of the pixel with negative polarity gradually increases, and finally both voltages reach to a same voltage level; the finally-reached voltage level is very close to a voltage of the common electrode VCOM, and thereby the panel displays a black image. Compared with the conventional manner of pixel electrode being discharged to common electrode VCOM (referring to FIG. 1b), firstly, the current on the common voltage VCOM according to the present invention is reduced and thus the power consumption on the common electrode VCOM is decreased; secondly, the voltage level of the common electrode VCOM according to the present invention is more stable, which facilitates the improvement of display quality.

A black pixel inserting method for 3D display according to the first exemplary embodiment is that:

Step 100: multiple data lines Data for supplying data signals, multiple gate lines Gate for supplying scan signals, and multiple pixels P are provided. Each of the pixels P is electrically connected to one of the data lines Data and one of the gate lines Gate. A polarity of each of the pixels P is opposite to that of neighboring pixels P on the top, bottom, left and right of the pixel P.

Step 200: multiple control transistors T are provided for connecting a (2n+1)th row of pixel with a (2n+2)th row of pixel in each same column.

Step 300: multiple control signal terminals are provided to electrically connected with the control transistors T. When the control signal terminals are applied with a logic low voltage, the control transistors T are switched-off; whereas when the control signal terminals are applied with a logic high voltage, the control transistors T are switched-on.

It is indicated that, as to a row inversion panel, the design solution according to the first exemplary embodiment also can be applied thereto.

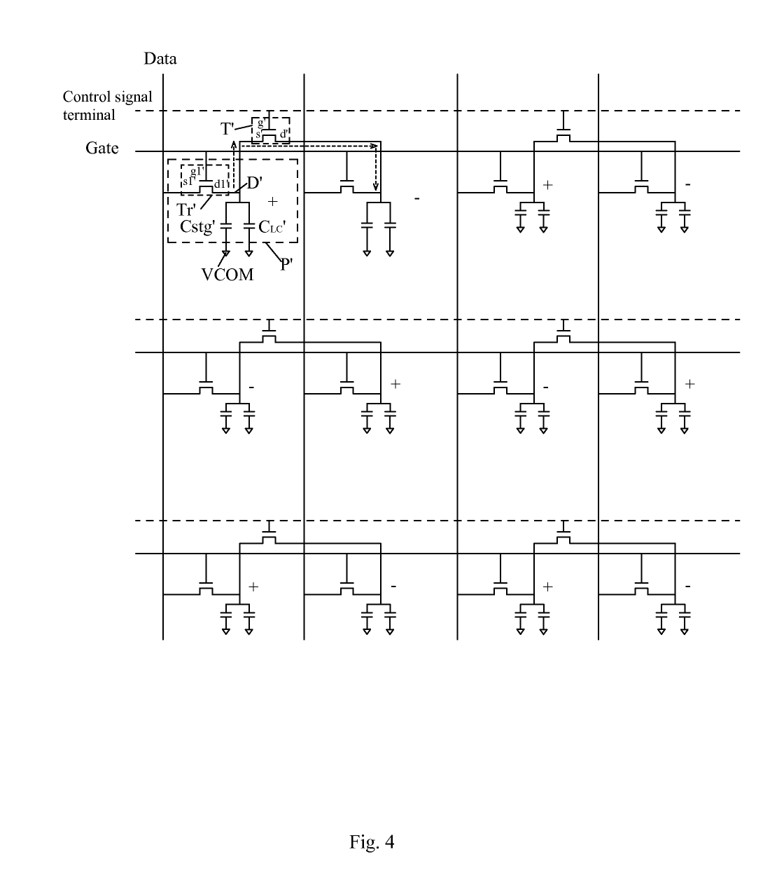

Referring to FIG. 4, which is a schematic circuit diagram of a circuit using the black pixel inserting method for 3D display according to a second exemplary embodiment. In the second exemplary embodiment, the panel is a type of dot inversion panel. The symbols “+” and “−” in FIG. 4 respectively represent positive polarity and negative polarity of pixel electrode voltages. The circuit in the second exemplary embodiment includes multiple data lines Data for supplying data signals, multiple gate lines Gate for supplying scan signals, multiple control signal terminals, a common electrode VCOM, multiple pixels P′ defined by the data lines Data and the gate lines Gate, and multiple control transistors T′. Each of the pixels P′ is electrically connected to one of the data lines Data and one of the gate lines Gate. Each of the pixels P′ includes a pixel transistor Tr′, a pixel electrode D′, a storage capacitor C_{stg}′, and a liquid crystal capacitor C_{LC}′. Each of the control transistors T′ includes a gate g′, a source s′ and a drain d′. The pixel transistor Tr′ includes a first gate g1′, a first source s1′ and a first drain d1′.

A (2n+1)th row of pixel and a (2n+2)th (n=0, 1, 2, . . . ) row of pixel in a same column are electrically connected by one of the control transistors T′. The source s′ of the control transistor T′ is electrically connected to the pixel electrode D′ of the (2n+1)th row of pixel, and the drain d′ of the control transistor T′ is electrically connected to the pixel electrode D′ of the (2n+2)th row of pixel. The gates g′ of the control transistors T′ arranged in a same row are electrically connected to a same one of the control signal terminals.

The first gates g1′ of the pixel transistors Tr′ of the pixels P′ arranged in a same row are electrically connected to a same one of the gate lines Gate. The first sources s1′ of the pixel transistors Tr′ of the pixels P′ arranged in a same column are electrically connected to a same one of the data lines Data. The first drain d1′ of the pixel transistor Tr′ is electrically connected to the pixel electrode D′. A top plate of the storage capacitor C_{stg}′ and a top plate of the liquid crystal capacitor C_{LC}′ are together electrically connected to the pixel electrode D′, a bottom plate of the storage capacitor C_{stg}′ is electrically connected to the common electrode VCOM, and a bottom plate of the liquid crystal capacitor C_{LC}′ is electrically connected to the common electrode VCOM.

The control transistors T′ and the pixel transistor Tr′ are thin film transistors.

A polarity of each of the pixels P′ is opposite to that of neighboring pixels P′ on the top, bottom, left and right of the pixel P′.

Specifically, a path indicated by the arrows in FIG. 4 is a current flowing path during black insertion. The current flows from the pixel electrode with positive polarity to the pixel electrode with negative polarity. An operation process of the circuit using the black pixel inserting method for 3D display according to the second exemplary embodiment may be that: during left-eye and right-eye images are written, the control signal terminals are applied with a logic low voltage, the control transistors T′ are switched-off; when a black image is needed to be written, the control signal terminals are applied with a logic high voltage, the control transistors T′ at this time are switched-on, since the polarities of the (2n+1)th column of pixel and the (2n+2)th (n=0, 1, 2, . . . ) column of pixel in a same row are opposite, a voltage of the pixel with positive polarity gradually decreases, while a voltage of the pixel with negative polarity gradually increases, and finally both voltages reach to a same voltage level, the finally-reached voltage level is very close to a voltage of common electrode VCOM, and thus the panel displays a black image.

The black pixel inserting method for 3D display according to the second exemplary embodiment is that:

Step100′: multiple data lines Data for supplying data signals, multiple gate lines Gate for supplying scan signals, and multiple pixels P′ are provided. Each of the pixels P′ is electrically connected to one of the data lines Data and one of the gate lines Gate. The polarity of each of the pixels P′ is opposite to that of neighboring pixels P′ on the top, bottom, left and right of the pixel P′.

Step 200′: multiple control transistors T′ are provided for connecting a (2n+1)th column of pixel and a (2n+2)th column of pixel in each same row.

Step 300′: multiple control signal terminals are provided to electrically connect with the control transistors T′. When the control signal terminals are applied with a logic low voltage, the control transistors T′ are switched off; whereas when the control signal terminals are applied with a logic high voltage, the control transistors T′ are switched-on.

It is indicated that, as to a column inversion panel, the design solution according to the second exemplary embodiment also can be applied thereto.

In a large-sized panel design, in order to improve the problem of large viewing angle color shift, each pixel unit of liquid crystal pixels generally are divided into two or more domains, such design manner also can adopt the black insertion of the present invention.

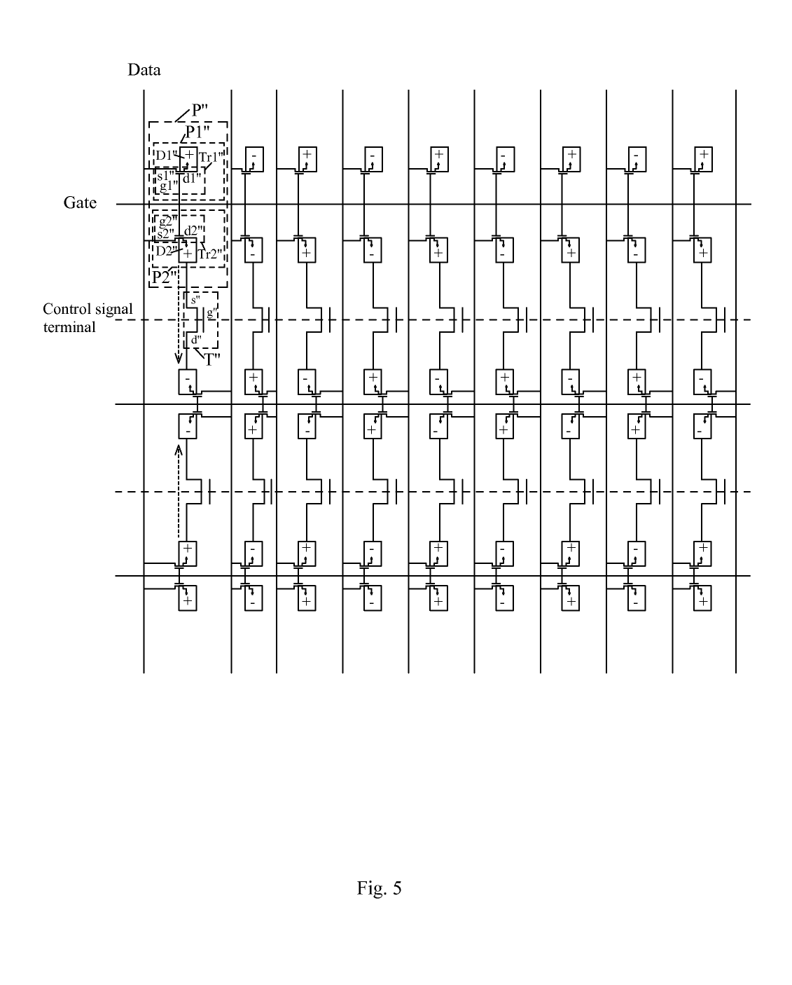

Referring to FIG. 5, which is a schematic circuit diagram of a circuit using the black pixel inserting method for 3D display according to a third exemplary embodiment. In the third exemplary embodiment, the panel is a type of dot inversion panel. A path indicated by the arrows in FIG. 5 is a current flowing path during black insertion. The symbols “+” and “−” respectively represent positive polarity and negative polarity of pixel electrode voltages. The circuit in the third exemplary embodiment includes multiple data lines Data for supplying data signals, multiple gate lines Gate for supplying scan signals, multiple control signal terminals, a common electrode VCOM, multiple pixels P″ defined by the data lines Data and the gate lines Gate, and multiple control transistors T″. Each of the control transistors T″ includes a gate g″, a source s″ and a drain d″. Each of the pixels P″ is electrically connected to one of the data lines Data and one of the gate lines Gate. Each of the pixels P″ are divided into two domains, i.e., an upper half domain P1″ and a lower half domain P2″. A first pixel electrode D1″ in the upper half domain P1″ and a second pixel electrode D2″ in the lower half domain P2″ have a same polarity. The upper half domain P1″ includes a first pixel transistor Tr1″ and the first pixel electrode D1″. The lower half domain P2″ includes a second pixel transistor Tr2″ and the second pixel electrode D2″. The first pixel transistor Tr1″ includes a gate g1″, a source s1″ and a drain d1″. The second pixel transistor Tr2″ includes a gate g2″, a source s2″ and a drain d2″. The drain d1″ of the first pixel transistor Tr1″ is electrically connected to the first pixel electrode D1″, and the drain d2″ of the second pixel transistor Tr2″ is electrically connected to the second pixel electrode D2″. The gates g1″ of the first pixel transistors Tr1″ and the gates g2″ of the second pixel transistors Tr2″ of the pixels P″ arranged in a same row are connected to a same one of the gate lines Gate. The source s1″ of the first pixel transistor Tr1″ and the source s2″ of the second pixel transistor Tr2″ of the pixel arranged in a mth (m=1, 2 . . . ) row are electrically connected to a same one of the data lines Data. The source s1″ of the first pixel transistor Tr1″ and the source s2″ of the second pixel transistor Tr2″ of the pixel arranged in a (m+1)th row are electrically connected to another same one of the data lines Data.

The lower half domain P2″ of the mth row of pixel and the upper half domain P1″ of the (m+1)th row of pixel arranged in a same column are electrically connected by one of the control transistors T″. The source s″ of the control transistor T″ is electrically connected to the pixel electrode D2″ in the lower half domain P2″ of the mth row of pixel P″, the drain d″ of the control transistor T″ is electrically connected to the pixel electrode D1″ in the upper half domain P1″ of the (m+1)th row of pixel P″. The gates g″ of the control transistors T″ arranged in a same row are electrically connected to a same one of the control signal terminals.

The control transistors T″, the first pixel transistor Tr1″ and the second pixel transistor Tr2′ are thin film transistors.

A polarity of each of the pixels P″ is opposite to that of neighboring pixels P″ on the top, bottom, left and right of the pixel P″.

Specifically, an operation process of the circuit using the black pixel inserting method for 3D display according to the third exemplary embodiment may be that: during left-eye and right-eye images are written, the control signal terminals are applied with a logic low voltage, the control transistors T″ are switched-off, and the pixels are normally charged; when a black image is needed to be inserted, the control signal terminals are applied with a logic high voltage, the control transistors T″ are switched-on, so that voltages of the pixels P″ with positive polarity gradually decrease, voltages of the pixels P″ with negative polarity gradually increase, and finally all voltages reach close to a voltage of common electrode VCOM, and thereby achieving the display of black image.

A black pixel inserting method for 3D display according to the third exemplary embodiment may be that:

Step 100″: multiple data lines Data for supplying data signals, multiple gate lines Gate for supplying scan signals, and multiple pixels P″ are provided. Each of the pixels P″ is electrically connected to one of the data lines Data and one of the gate lines Gate. The polarity of each of the pixels P″ is opposite to that of neighboring pixels P″ on the top, bottom, left and right of the pixel P″. Each of the pixels P″ includes an upper half domain P1″ and a lower half domain P2″.

Step 200″: multiple control transistors T″ are provided for connecting the lower half domain P2″ of a mth row of pixel with the upper half domain P1″ of a (m+1)th row of pixel in each same column.

Step300″: multiple control signal terminals are provided to electrically connect with the control transistors T″. When the control signal terminals are applied with a logic low voltage, the control transistors T″ are switched-off; whereas when the control signal terminals are applied with a logic high voltage, the control transistors T″ are switched-on.

In summary, the present invention provides a black pixel inserting method for 3D display and a circuit using the method, aiming at commonly used inversion manners such as column inversion, row inversion and dot inversion, etc., re-designing a 3D black inserting manner of panel. As to the commonly used inversion manner, pixels with positive polarity and pixels with negative polarity respectively generally are a half of all pixels during normal display of panel, according to the present invention, pixel electrodes with different polarities are electrically connected by a thin film transistor. When there is a need of black insertion, the thin film transistor connecting the pixel electrodes with different polarities is switched on by a control signal, the voltage of pixel with positive polarity decreases, the voltage of pixel with negative polarity increases, and finally both voltages reach close to a voltage of common electrode, and thereby achieving the display of black image. Accordingly, the present invention would not increase the load of the common electrode circuitry and power consumption of whole panel. Furthermore, the voltage between the source and the drain (corresponding to positive and negative pixel electrodes) of the thin film transistor for discharging is large, and thus the discharging speed is raised consequently.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A black pixel inserting method for 3D display, comprising:
step 100: providing a plurality of data lines for supplying data signals, a plurality of gate lines for supplying scan signals, and a plurality of pixels, wherein each of the plurality of pixels is electrically connected to one of the plurality of data line and one of the plurality of gate lines, and a polarity of each of the plurality of pixels is opposite to that of neighboring pixels on the top, bottom, left and right of the pixel;
step 200: providing a plurality of control transistors for connecting the pixels with different polarities; and
step 300: providing a plurality of control signal terminals electrically connected with the control transistors, wherein when the plurality of control signal terminals are applied with a logic low voltage, the plurality of control transistors are switched-off, and when the plurality of control signal terminals are applied with a logic high voltage, the plurality of control transistors are switched-on.

2. The black pixel inserting method as claimed in claim 1, wherein in the step 200, each of the plurality of control transistors is electrically connected a (2n+1)th row of pixel with a (2n+2)th row of pixel arranged in a same column.

3. The black pixel inserting method as claimed in claim 1, wherein in the step 200, each of the plurality of control transistors is electrically connected a (2n+1)th column of pixel with a (2n+2)th column of pixel arranged in a same row.

4. The black pixel inserting method as claimed in claim 1, wherein in the step 100, each of the plurality of pixels comprises an upper half domain and a lower half domain, the upper half domain and the lower half domain have a same polarity.

5. The black pixel inserting method as claimed in claim 4, wherein in the step 200, each of the plurality of control transistors is electrically connected the lower half domain of a mth row of pixel with the upper half domain of a (m+1)th row of pixel arranged in a same column.

6. The black pixel inserting method as claimed in claim 1, wherein when one of the plurality of control transistors is switched-on, a voltage of the pixel with positive polarity connected with the switched-on control transistor deceases, a voltage of the pixel with negative polarity connected with the switched-on control transistor increases, and finally the voltages reach close to a voltage of common electrode.

7. A circuit using the black pixel inserting method for 3D display as claimed in claim 1, comprising:
a plurality of data lines for supplying data signals, a plurality of gate lines for supplying scan signals, a plurality of control signal terminals, a common electrode, a plurality of pixels defined by the plurality of data lines and the plurality of gate lines, and a plurality of control transistors; wherein each of the plurality of pixels is electrically connected to one of the plurality of data lines and one of the plurality of gate lines, each of the plurality of pixels comprises a pixel transistor, a pixel electrode, a storage capacitor and a liquid crystal capacitor; each of the plurality of control transistors comprises a gate, a source and a drain, the pixel transistor comprises a first gate, a first source and a first drain;
a (2n+1)th row of pixel and a (2n+2)th row of pixel arranged in a same column are connected by one of the plurality of control transistors, the source of the control transistor is electrically connected to the pixel electrode of the (2n+1)th row of pixel, the drain of the control transistor is electrically connected to the pixel electrode of the (2n+2)th row of pixel; the gates of the control transistors arranged in a same row are connected to a same one of the plurality of control signal terminals;
wherein the first gates of the pixel transistors of the pixels arranged in a same row are electrically connected to a same one of the plurality of gate lines, the first gates of the pixel transistors of the pixels arranged in a same column are electrically connected to a same one of the plurality of data lines, and the first drain of the pixel transistor is electrically connected to the pixel electrode;
a top plate of the storage capacitor and a top plate of the liquid crystal capacitor are together electrically connected to the pixel electrode, a bottom plate of the storage capacitor is electrically connected to the common electrode, and a bottom plate of the liquid crystal capacitor is electrically connected to the common electrode.

8. The circuit as claimed in claim 7, wherein the plurality of control transistors and the pixel transistor all are thin film transistors.

9. The circuit as claimed in claim 7, wherein a polarity of each of the plurality of pixels is opposite to that of neighboring pixels on the top, bottom, left and right of the pixel.

10. A circuit using the black pixel inserting method for 3D display as claimed in claim 1, comprising:
a plurality of data lines for supplying data signals, a plurality of gate lines for supplying scan signals, a plurality of control signal terminals, a common electrode, a plurality of pixels defined by the plurality of data lines and the plurality of gate lines, and a plurality of control transistors; wherein each of the plurality of pixels is electrically connected to one of the plurality of data lines and one of the plurality of gate lines, each of the plurality of pixels comprises a pixel transistor, a pixel electrode, a storage capacitor and a liquid crystal capacitor; each of the plurality of control transistors comprises a gate, a source and a drain, the pixel transistor comprises a first gate, a first source and a first drain;
a (2n+1)th column of pixel and a (2n+2)th column of pixel arranged in a same row are connected by one of the plurality of control transistors, the source of the control transistor is electrically connected to the pixel electrode of the (2n+1)th column of pixel, the drain of the control transistor is electrically connected to the pixel electrode of the (2n+2)th column of pixel; the gates of the control transistors arranged in a same row are electrically connected to a same one of the plurality of control signal terminals;
wherein the first gates of the pixel transistors of the pixels arranged in a same row are electrically connected to a same one of the plurality of gate lines, the first gates of the pixel transistors of the pixels arranged in a same column are electrically connected to a same one of the plurality of data lines, the first drain of the pixel transistor is electrically connected to the pixel electrode; a top plate of the storage capacitor and a top plate of the liquid crystal capacitor are together electrically connected to the pixel electrode, a bottom plate of the storage capacitor is electrically connected to the common electrode, and a bottom plate of the liquid crystal capacitor is electrically connected to the common electrode.

11. The circuit as claimed in claim 10, wherein the plurality of control transistors and the pixel transistor all are thin film transistors.

12. The circuit as claimed in claim 10, wherein a polarity of each of the plurality of pixels is opposite to that of neighboring pixels on the top, bottom, left and right of the pixel.

13. A circuit using the black pixel inserting method for 3D display as claimed in claim 1, comprising:
a plurality of data lines for supplying data signals, a plurality of gate lines for supplying scan signals, a plurality of control signal terminals, a common electrode, a plurality of pixels defined by the plurality of data lines and the plurality of gate lines, and a plurality of control transistors; wherein each of the plurality of pixels is electrically connected to one of the plurality of data lines and one of the plurality of gate lines;
wherein each of the plurality of control transistors comprises a gate, a source and a drain; each of the plurality of pixels comprises an upper half domain and a lower half domain, a first pixel electrode in the upper half domain and a second pixel electrode in the lower half domain have a same polarity; the upper half domain comprises a first pixel transistor and the first pixel electrode, the lower half domain comprises a second pixel transistor and the second pixel electrode; the first pixel transistor comprises a gate, a source and a drain; the second pixel transistor comprises a gate, a source and a drain; the drain of the first pixel transistor is electrically connected to the first pixel electrode, and the drain of the second pixel transistor is electrically connected to the second pixel electrode;
wherein the gates of the first pixel transistors and the gates of the second pixel transistors of the pixels arranged in a same row are electrically connected to a same one of the plurality of the gate lines, the source of the first pixel transistor and the source of the second pixel transistor of the pixel arranged in a mth row are electrically connected to a same one of the plurality of data lines, the source of the first pixel transistor and the source of the second pixel transistor of the pixel arranged in a (m+1)th row are electrically connected to another same one of the plurality of data lines;
wherein the lower half domain of the mth row of pixel and the upper half domain of the (m+1)th row of pixel arranged in a same column are electrically connected by one of the plurality of control transistors, the source of the control transistor is electrically connected to the second pixel electrode in the lower half domain of the mth row of pixel, the drain of the control transistor is electrically connected to the first pixel electrode in the upper half domain of the (m+1)th row of pixel; the gates of the control transistors arranged in a same row are electrically connected to one of the plurality of control signal terminals.

14. The circuit as claimed in claim 13, wherein the plurality of control transistors, the first pixel transistor and the second pixel transistor all are thin film transistors.

15. The circuit as claimed in claim 13, wherein a polarity of each of the plurality of pixels is opposite to that of neighboring pixels on the top, bottom, left and right of the pixel.
